(19) United States
(12) Patent Application Publication
(10) Pub. No.: US 2008/0302429 A1
(43) Pub. Date: Dec. 11, 2008

(54) Smith water saver

(76) Inventors: Tim M. Savinar, San Francisco, CA (US); Karl G. Smith, San Francisco, CA (US)

Correspondence Address: Tim Savinar, 3019 Washington St, San Francisco, CA, 94115, US

(21) Appl. No.: 11/715,486

(22) Filed: Jun. 11, 2007

(51) Int. Cl. F16K 37/00

(52) U.S. Cl. 137/551

(57) ABSTRACT

The object of the SMITH WATER SAVER is to save and use the water in the hot water line, between the hot water heater and the faucet. When the user opens the hot water faucet, unheated water in the line begins to circulate back to the water heater in a return line. Ahead of the faucet is a throttle or thermocouple which while closed allows the unheated water to recirculate until it reaches a desired temperature (displayed by an indicator), at which time the throttle is opened, or a thermocouple opens automatically, and hot water flows out of the spigot.

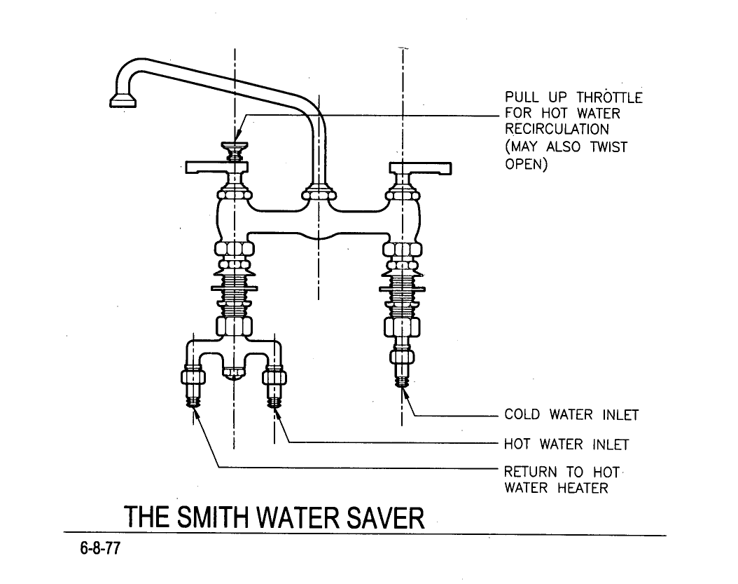

In every hot water utilization system, there is usually cold water in the hot water line between the hot water heater and the hot water faucet. When the user wishes to obtain hot water he turns on the hot water faucet and allows the cold water to run its course through the faucet. As soon as all the cold water in the line between the hot water heater and the hot water faucet has run out, the hot water begins to flow through the faucet. In this way, somewhere between one(1) and four(4) gallons of cold water(or maybe more) is wasted down the drain, depending on the distance to the hot water heater, while the user waits for the hot water to arrive from the hot water heater.

The object of the Water Saver is to take the unheated water, which is usually wasted in this way, and recirculate it back to the hot water heater rather than waste it. In plumbing systems which do not have a recirculating installations this device will save water.

The heart of the system is a throttle with a thermostatic valve or a thermocouple device located ahead of the hot water faucet handle, which allows the cold water to recirculate in a return line to the hot water heater until the water reaches a specific temperature(the throttle could be set) so specified. The throttle valve remains closed until the water from the hot water heater reaches the throttle. A number of possible indicators (such as a temperature gauge located in the throttle face) or some other type of indicator could be used. At this point, the throttle is either opened by the user or set by the gauge on top and allows hot water to flow from the spigot.

1. The inventors claim that the patentable subject is the rising of the hot water to the faucet in the system once the return line is opened.

2. The inventors claim that the patentable subject is the unique throttle valve which opens and closes access to the spigot.

3. The inventors claim that the patentable subject is the thermocouple valve opening and closing access to the spigot when preselected water temperatures are achieved.

4. The inventors claim that the patentable subject is the throttle valve which has a water temperature indicator so that the user can manually get hot water access to the spigot.
